(19) United States
(12) Patent Application Publication
(10) Pub. No.: US 2023/0229641 A1
(43) Pub. Date: Jul. 20, 2023

(54) NOVEL DATABASE SCHEMA CHANGE, RECORDING AND VERSION CONTROL METHOD AND PLATFORM

(71) Applicant: Bytebase (HongKong) Limited, Hong Kong (CN)

(72) Inventor: Tianzhou Chen, Hong Kong (CN)

(73) Assignee: Bytebase (HongKong) Limited, Hong Kong (CN)

(21) Appl. No.: 17/576,951

(22) Filed: Jan. 16, 2022

(51) Int. Cl. G06F 16/21; G06Q 10/06; G06F 16/25

(52) U.S. Cl. CPC G06F 16/213; G06Q 10/0633; G06Q 10/063118; G06F 16/25; G06F 16/219

(57) ABSTRACT

This application relates to systems, methods, devices, and other techniques for a novel database schema change, recording and version control.

### BACKGROUND OF THE INVENTION

This application relates to systems, methods, devices, and other techniques for a novel database schema change, recording and version control.

Methods and apparatus for changing database is available. However, systems, methods, devices, and other techniques for requesting database schema change, pre-validating prior to the change, reviewing the request, approving the request, recording the changes and controlling the database schema versions in an online collaborative fashion are very novel. In addition, the ways to detect database schema drift are also novel.

Therefore, it is desirable to have systems, methods, devices, and other techniques for a novel database schema change, recording and version control.

### SUMMARY OF THE INVENTION

This application relates to systems, methods, devices, and other techniques for a novel database schema change, recording and version control.

In some embodiments, the invention related here is a team collaboration platform for database schema change and version control. It is oriented towards teamwork, and we defined different roles (role), project (project), environment (Environment), the concept of a work issue and approval flow.

In some embodiments, by recording the changing version of the schema, one can know every change in the detail. In addition, if the change does not go through the platform at issue, the system is configured to record and catch these abnormalities (drift detection). The system and the platform can also work with a more professional Version Control System (VCS) Integration; thus, the system is configured to provide a more complete version management function.

In some embodiments, a database schema defines how data is organized within a relational database; this is inclusive of logical constraints such as, table names, fields, data types, and the relationships between these entities. Schemas commonly use visual representations to communicate the architecture of the database, becoming the foundation for an organization's data management discipline. This process of database schema design is also known as data modeling.

These data models serve a variety of roles, such as database users, database administrators, and programmers. For example, it can help database administrators manage normalization processes to avoid data duplication. Alternatively, it can enable analysts to navigate these data structures to conduct reporting or other valuable business analyses. These diagrams act as valuable documentation within the database management system (DBMS), ensuring alignment across various stakeholders.

A schema change is an alteration made to a collection of logical structures (or schema objects) in a database. Schema changes are generally made using structured query language (SQL) and are typically implemented during maintenance windows. When the business situation changes, the schema will be changed. For example, the rules in a game changes, thus the database schema describing the game will have to be changed. Also, because of the occurrences of using group order, one order to a restaurant can be combined by multiple orders by multiple customers. Therefore, the order to customer relationship could be a relation of multiple to multiple, thus not limited to one to one. Of course, the change of schema needs to go through a controlled procedure.

When we have schema change, we need a tool for version control, so that the changed part and the time of changing and the reasoning of the change can be recorded for auditing purposes.

In the database schema change process, the developer makes a specific request for the database schema change. Then the technical leaders or database administrators are assigned to review, approve and apply the database schema changes to the databases. During the process, there are different roles in the process, comprising : the developer, the technical leader and database administrator. The environment of database schema changes is not done at once. The changes are done by reviewing layer by layer of the environment of database schema and platforms. After very careful review and approval, the changes of database schema will be applied to the production environment. usually, there are three or four different environments. A usual development cycle that is comprised of four environments : development (engineer's local development environment, integrated testing, staging and production. For the relationship between database and database instance, one database instance can comprise of one or more databases.

In some embodiments, Project is defined as follows: During the daily working life, people are co-operating using format of project. Therefore, the project is a concept of container that contains the related people and matters for a specific working matter. The database schema changes are proposed by people and reviewed by people. The related database, people are related to a specific project.

In some embodiments, the Issue is defined as follows: In the process of a project, it may need to make many database schema changes operate. Each change corresponds to the submission of a new issue. Necessary changes, such as what kind of change was made, what database was changed, who initiated the change, and who will approve, and the environment to which these changes will be applied are recorded on this issue. For example, we describe the specific change, for a Data Definition Language, usually we call it DDL. The following is an example:

“ALTER TABLE customer ADD email TEXT;”

The language that interacts with the database is called SQL. SQL is divided into two categories, one is DDL, which is used to make structural changes. There is another category called Data Manipulation Language (DML). Used for data query. For example, the following statement is to list the email information of each customer.

“SELECT email FROM customer.”

In one proposed instance, the issue dashboard that we used to proceed with schema change includes Environment, Data definition language (DDL), Project, Database, Database instance, proposer of database schema change, reviewer and approver of the database schema change.

For each DDL change proposed by the developer, for example, the statement of “ALTER TABLE customer ADD email TEXT”, it will go through all four environments: development (engineer's local development environment, integrated testing, staging and production. Between integrated testing and staging steps, there are reviews and approves need to be done for the schema changes to proceed. Between staging and production steps, there are reviews and approves need to be done for the schema changes to proceed.

After each environmental change is completed, it will be recorded. Because we also recorded the previous version, so we are also recording the difference between the versions.

Some environments can skip the approval process, like this Development environment and test environment.

The following is the detail example that a flow of database schema change.

For example, one developer wants to add SQL statement of “ ALTER TABLE customer ADD email TEXT” to the database schema. The first step, in the schema change interface, the developer needs to choose the database or databases that he or she wants to request to add the SQL statement of “ ALTER TABLE customer ADD email TEXT”.

The second step, the developer wants to input the schema change content, here, is the adding of the statement of “ ALTER TABLE customer ADD email TEXT”.

The third step, the developer also wants to assign the reviewer/approver role to persons that could be, but not limited to one or more administrator, reviewers, senior engineers, managers, database administrators etc.

After these steps, the work issue is created and wait for the reviewer/approver to approve. During the approval process, the reviewer/approver will see some automatic check by the platform. The automatic check comprises database connection check, migration schema correctness check, syntax error check, backward compatibility check, and optimization check. Here, the reviewers/approvers can do detail check for database connection check, migration schema correctness check, syntax error check, backward compatibility check, and optimization check. After the request is approved, the new schema is recorded with time stamp with all the schema change details, such who is the requester, what is the request, who is the approver and when is the request approved. Meanwhile, the old schema without above change is also recorded with time stamp.

After the approval and record of the schema change, the work issue is resolved. The change in the schema can be checked and highlighted. Sometimes, the change of the schema is not one way communication only, the reviewer/approver will have discussion with the requester before the change can be approved and work issue is resolved.

In addition, we have defined a change process, if the user is making changes on our platform, then we will record the changed version. But if the user does not make changes through our platform, that will lead to inconsistency between the real schema information and our recorded schema . We will report this error. This function is called drift detection.

Also, the Schema file describing the database can also be saved in a special version control system (Version Control System/VCS). Our product supervision controls the changes of the schema description file on the VCS. Once there is a change, it will automatically trigger our pipeline to make real database changes.

### BRIEF DESCRIPTION OF THE DRAWINGS

FIG. 1 shows an example of a method of doing a novel database schema change, recording and version control.

FIG. 2 shows another example of another method of doing a novel database schema change, recording and version control.

FIG. 3 shows a third example of a third method of doing a novel database schema change, recording and version control.

FIG. 4 shows a fourth example of a fourth method of doing a novel database schema change, recording and version control.

### DETAILED DESCRIPTION OF THE INVENTION

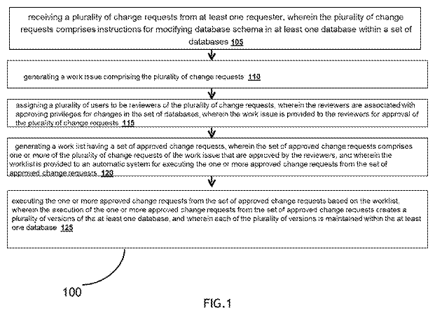

FIG. 1 shows an example of a method of doing a novel database schema change, recording and version control.

In some embodiments, the method comprises a step 105 of receiving a plurality of change requests from at least one requester, wherein the plurality of change requests comprises instructions for modifying database schema in at least one database within a set of databases.

In some embodiments, the method comprises a step 110 of generating a work issue comprising the plurality of change requests.

In some embodiments, the method comprises a step 115 of assigning a plurality of users to be reviewers of the plurality of change requests, wherein the reviewers are associated with approving privileges for changes in the set of databases, wherein the work issue is provided to the reviewers for approval of the plurality of change requests.

In some embodiments, the method comprises a step 120 of generating a work list having a set of approved change requests, wherein the set of approved change requests comprises one or more of the plurality of change requests of the work issue that are approved by the reviewers, and wherein the worklist is provided to an automatic system for executing the one or more approved change requests from the set of approved change requests.

In some embodiments, the method comprises a step 125 of executing the one or more approved change requests from the set of approved change requests based on the worklist, wherein the execution of the one or more approved change requests from the set of approved change requests creates a plurality of versions of the at least one database, and wherein each of the plurality of versions is maintained within the at least one database.

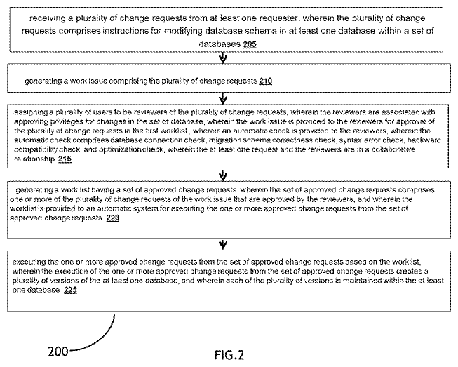

FIG. 2 shows another example of another method of doing a novel database schema change, recording and version control.

In some embodiments, the method comprises a step 205 of receiving a plurality of change requests from at least one requester, wherein the plurality of change requests comprises instructions for modifying database schema in at least one database within a set of databases.

In some embodiments, the method comprises a step 210 of generating a work issue comprising the plurality of change requests.

In some embodiments, the method comprises a step 215 of assigning a plurality of users to be reviewers of the plurality of change requests, wherein the reviewers are associated with approving privileges for changes in the set of database, wherein the work issue is provided to the reviewers for approval of the plurality of change requests in the first worklist , wherein an automatic check is provided to the reviewers, wherein the automatic check comprises database connection check, migration schema correctness check, syntax error check, backward compatibility check, and optimization check, wherein the at least one request and the reviewers are in a collaborative relationship.

In some embodiments, the method comprises a step 220 of generating a work list having a set of approved change requests, wherein the set of approved change requests comprises one or more of the plurality of change requests of the work issue that are approved by the reviewers, and wherein the worklist is provided to an automatic system for executing the one or more approved change requests from the set of approved change requests.

In some embodiments, the method comprises a step 225 of executing the one or more approved change requests from the set of approved change requests based on the worklist, wherein the execution of the one or more approved change requests from the set of approved change requests creates a plurality of versions of the at least one database, and wherein each of the plurality of versions is maintained within the at least one database.

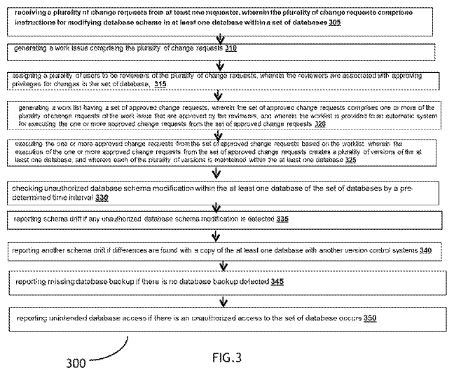

FIG. 3 shows a third example of a third method of doing a novel database schema change, recording and version control.

In some embodiments, the method comprises a step 305 of receiving a plurality of change requests from at least one requester, wherein the plurality of change requests comprises instructions for modifying database schema in at least one database within a set of databases;

In some embodiments, the method comprises a step 310 of generating a work issue comprising the plurality of change requests.

In some embodiments, the method comprises a step 315 of assigning a plurality of users to be reviewers of the plurality of change requests, wherein the reviewers are associated with approving privileges for changes in the set of database, wherein the work issue is provided to the reviewers for approval of the plurality of change requests in the first worklist , wherein an automatic check is provided to the reviewers, wherein the automatic check comprises database connection check, migration schema correctness check, syntax error check, backward compatibility check, and optimization check.

In some embodiments, the method comprises a step 320 of generating a work list having a set of approved change requests, wherein the set of approved change requests comprises one or more of the plurality of change requests of the work issue that are approved by the reviewers, and wherein the worklist is provided to an automatic system for executing the one or more approved change requests from the set of approved change requests.

In some embodiments, the method comprises a step 325 of executing the one or more approved change requests from the set of approved change requests based on the worklist, wherein the execution of the one or more approved change requests from the set of approved change requests creates a plurality of versions of the at least one database, and wherein each of the plurality of versions is maintained within the at least one database.

In some embodiments, the method comprises a step 330 of checking unauthorized database schema modification within the at least one database of the set of databases by a pre-determined time interval.

In some embodiments, the method comprises a step 335 of reporting schema drift if any unauthorized database schema modification is detected .

In some embodiments, the method comprises a step 340 of reporting another schema drift if differences are found with a copy of the at least one database with another version control systems.

In some embodiments, the method comprises a step 345 of reporting missing database backup if there is no database backup detected.

In some embodiments, the method comprises a step 350 of reporting unintended database access if there is an unauthorized access to the set of database occurs.

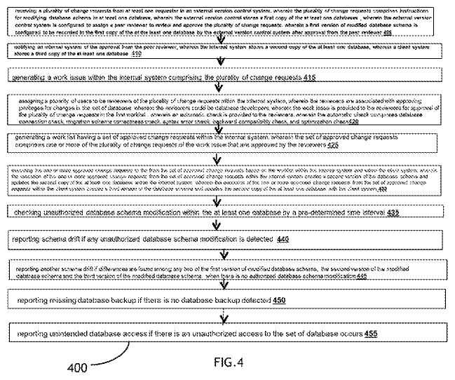

FIG. 4 shows a fourth example of a fourth method of doing a novel database schema change, recording and version control.

In some embodiments, the method comprises a step 405 of receiving a plurality of change requests from at least one requester in an external version control system, wherein the plurality of change requests comprises instructions for modifying database schema in at least one database, wherein the external version control stores a first copy of the at least one databases , wherein the external version control system is configured to assign a peer reviewer to review and approve the plurality of change requests, wherein a first version of modified database schema is configured to be recorded in the first copy of the at the least one database by the external version control system after approval from the peer reviewer.

In some embodiments, the method comprises a step 410 of notifying an internal system of the approval from the peer reviewer, wherein the internal system stores a second copy of the at least one database, wherein a client system stores a third copy of the at least one database.

In some embodiments, the method comprises a step 415 of generating a work issue within the internal system comprising the plurality of change requests.

In some embodiments, the method comprises a step 420 of assigning a plurality of users to be reviewers of the plurality of change requests within the internal system, wherein the reviewers are associated with approving privileges for changes in the set of database, wherein the reviewers could be database developers, wherein the work issue is provided to the reviewers for approval of the plurality of change requests in the first worklist, wherein an automatic check is provided to the reviewers, wherein the automatic check comprises database connection check, migration schema correctness check, syntax error check, backward compatibility check, and optimization check.

In some embodiments, the method comprises a step 425 of generating a work list having a set of approved change requests within the internal system, wherein the set of approved change requests comprises one or more of the plurality of change requests of the work issue that are approved by the reviewers.

In some embodiments, the method comprises a step 430 of executing the one or more approved change requests to the from the set of approved change requests based on the worklist within the internal system and within the client system; wherein the execution of the one or more approved change requests from the set of approved change requests within the internal system creates a second version of the database schema and updates the second copy of the at least one database within the internal system, wherein the execution of the one or more approved change requests from the set of approved change requests within the client system creates a third version of the database schema and updates the second copy of the at least one database with the client system.

In some embodiments, the method comprises a step 435 of checking unauthorized database schema modification within the at least one database by a pre-determined time interval.

In some embodiments, the method comprises a step 440 of reporting schema drift if any unauthorized database schema modification is detected.

In some embodiments, the method comprises a step 445 of reporting another schema drift if differences are found among any two of the first version of modified database schema, the second version of the modified database schema and the third version of the modified database schema, when there is no authorized database schema modification.

In some embodiments, the method comprises a step 450 of reporting missing database backup if there is no database backup detected.

In some embodiments, the method comprises a step 455 of reporting unintended database access if there is an unauthorized access to the set of database occurs.

1. A method managing schema changes, comprising:
receiving a plurality of change requests from at least one requester, wherein the plurality of change requests comprises instructions for modifying database schema in at least one database within a set of databases;
generating a work issue comprising the plurality of change requests;
assigning a plurality of users to be reviewers of the plurality of change requests, wherein the reviewers are associated with approving privileges for changes in the set of databases, wherein the work issue is provided to the reviewers for approval of the plurality of change requests;
generating a work list having a set of approved change requests, wherein the set of approved change requests comprises one or more of the plurality of change requests of the work issue that are approved by the reviewers, and wherein the worklist is provided to an automatic system for executing the one or more approved change requests from the set of approved change requests; and
executing the one or more approved change requests from the set of approved change requests based on the worklist, wherein the execution of the one or more approved change requests from the set of approved change requests creates a plurality of versions of the at least one database, and wherein each of the plurality of versions is maintained within the at least one database.

2. A method managing schema changes, comprising:
receiving a plurality of change requests from at least one requester, wherein the plurality of change requests comprises instructions for modifying database schema in at least one database within a set of databases;
generating a work issue comprising the plurality of change requests;
assigning a plurality of users to be reviewers of the plurality of change requests, wherein the reviewers are associated with approving privileges for changes in the set of database, wherein the work issue is provided to the reviewers for approval of the plurality of change requests in the first worklist , wherein an automatic check is provided to the reviewers, wherein the automatic check comprises database connection check, migration schema correctness check, syntax error check, backward compatibility check, and optimization check, wherein the at least one request and the reviewers are in a collaborative relationship;
generating a work list having a set of approved change requests, wherein the set of approved change requests comprises one or more of the plurality of change requests of the work issue that are approved by the reviewers, and wherein the worklist is provided to an automatic system for executing the one or more approved change requests from the set of approved change requests; and
executing the one or more approved change requests from the set of approved change requests based on the worklist, wherein the execution of the one or more approved change requests from the set of approved change requests creates a plurality of versions of the at least one database, and wherein each of the plurality of versions is maintained within the at least one database.

3. A method managing schema changes, comprising:
receiving a plurality of change requests from at least one requester, wherein the plurality of change requests comprises instructions for modifying database schema in at least one database within a set of databases;
generating a work issue comprising the plurality of change requests;
assigning a plurality of users to be reviewers of the plurality of change requests, wherein the reviewers are associated with approving privileges for changes in the set of database, wherein the work issue is provided to the reviewers for approval of the plurality of change requests in the first worklist , wherein an automatic check is provided to the reviewers, wherein the automatic check comprises database connection check, migration schema correctness check, syntax error check, backward compatibility check, and optimization check;
generating a work list having a set of approved change requests, wherein the set of approved change requests comprises one or more of the plurality of change requests of the work issue that are approved by the reviewers, and wherein the worklist is provided to an automatic system for executing the one or more approved change requests from the set of approved change requests;
executing the one or more approved change requests from the set of approved change requests based on the worklist, wherein the execution of the one or more approved change requests from the set of approved change requests creates a plurality of versions of the at least one database, and wherein each of the plurality of versions is maintained within the at least one database;
checking unauthorized database schema modification within the at least one database of the set of databases by a pre-determined time interval;
reporting schema drift if any unauthorized database schema modification is detected ;
reporting another schema drift if differences are found with a copy of the at least one database with another version control systems;
reporting missing database backup if there is no database backup detected; and
reporting unintended database access if there is an unauthorized access to the set of database occurs.

4. A method of managing schema changes, comprising:
receiving a plurality of change requests from at least one requester in an external version control system, wherein the plurality of change requests comprises instructions for modifying database schema in at least one database, wherein the external version control stores a first copy of the at least one databases , wherein the external version control system is configured to assign a peer reviewer to review and approve the plurality of change requests, wherein a first version of modified database schema is configured to be recorded in the first copy of the at the least one database by the external version control system after approval from the peer reviewer;
notifying an internal system of the approval from the peer reviewer, wherein the internal system stores a second copy of the at least one database, wherein a client system stores a third copy of the at least one database;
generating a work issue within the internal system comprising the plurality of change requests;
assigning a plurality of users to be reviewers of the plurality of change requests within the internal system, wherein the reviewers are associated with approving privileges for changes in the set of database, wherein the reviewers could be database developers, wherein the work issue is provided to the reviewers for approval of the plurality of change requests in the first worklist , wherein an automatic check is provided to the reviewers, wherein the automatic check comprises database connection check, migration schema correctness check, syntax error check, backward compatibility check, and optimization check;
generating a work list having a set of approved change requests within the internal system, wherein the set of approved change requests comprises one or more of the plurality of change requests of the work issue that are approved by the reviewers;
executing the one or more approved change requests to the from the set of approved change requests based on the worklist within the internal system and within the client system; wherein the execution of the one or more approved change requests from the set of approved change requests within the internal system creates a second version of the database schema and updates the second copy of the at least one database within the internal system, wherein the execution of the one or more approved change requests from the set of approved change requests within the client system creates a third version of the database schema and updates the second copy of the at least one database with the client system,
checking unauthorized database schema modification within the at least one database by a pre-determined time interval;
reporting schema drift if any unauthorized database schema modification is detected ;
reporting another schema drift if differences are found among any two of the first version of modified database schema, the second version of the modified database schema and the third version of the modified database schema, when there is no authorized database schema modification;
reporting missing database backup if there is no database backup detected; and
reporting unintended database access if there is an unauthorized access to the set of database occurs.
